(19) United States
(12) Patent Application Publication
(10) Pub. No.: US 2006/0243807 A1
(43) Pub. Date: Nov. 2, 2006

(54) Method of controlling computer through reading bar code as well as control software and means therefor

(76) Inventor: Tse-Min Tien, Taoyuan County (TW)

Correspondence Address: TROXELL LAW OFFICE PLLC, SUITE 1404, 5205 LEESBURG PIKE, FALLS CHURCH, VA, 22041, US

(21) Appl. No.: 11/117,365

(22) Filed: Apr. 29, 2005

(51) Int. Cl. G06K 7/10

(52) U.S. Cl. 235/462.15

(57) ABSTRACT

A method of controlling a computer to execute relevant actions through reading bar codes includes the steps of using an optical identifying unit to scan at least one bar code and convert the read bar code into a digital signal, inputting the digital signal to an operating system of the computer via a peripheral interface, such as USB, PS2, RS232, etc., using related control software to map the received digital signal to a corresponding synopsis of functions to execute in the control software, locating index and data in the synopsis corresponding to the digital signal, and executing at least one control procedure corresponding to the located index and data to drive the computer to execute relevant actions. The method of controlling a computer through reading bar code may substitute for the conventional input peripherals and reduce previous complicate control procedures to only one simple movement of reading a bar code.

### FIELD OF THE INVENTION

The present invention relates to a method of controlling computer through reading bar code, and more particularly to a method of controlling computer in which an optical identifying unit is used to scan a bar code and input the read bar code to an operating system of the computer, and related control software in the operating system receives the input bar code and executes a control procedure in a synopsis of the control software corresponding to the read bar code to drive the computer to do relevant actions.

### BACKGROUND OF THE INVENTION

The function and performance of a personal computer has been largely upgraded due to constant and rapid developments in the computer technical field. For example, the operating speed of central processing unit, the volume of hard disk, the volume of memory, and the performance of display card, all have been increased. Moreover, the personal computer has been widely used in more and more applications.

The personal computer is used not only in word processing, small-size databank processing, and programming, but also in processing sound and image data that require high-speed operation and high-volume storage. However, there is not much change in the input control interface for the personal computer. Although aural input control has been developed, most users use a mouse or a keyboard to input for controlling the personal computer. The mouse and the keyboard are not so efficient when multiple accurate procedures are required to execute a series of instructions. Generally speaking, the following disadvantages are found in using the mouse or the keyboard to input instructions:
1. When a mouse is used to control and execute a multi-procedure instruction, it is necessary to operate the mouse to move the cursor to an icon of a desired program, and then click the left or the right key on the mouse to select the icon for opening the desired program. When the desired program is opened, the mouse is operated again to move the cursor to an instruction bar, from which a desired instruction to execute is selected by clicking the mouse. Sometimes, a pull-down menu would appear to show more instructions when clicking the mouse to select an instruction bar. In some cases, such as using the mouse to shift a slider on the computer screen, it is not easy for the user to precisely reach a desired position.
2. When a keyboard is used to input an instruction, arrow keys are used to move the cursor to an instruction bar, and the Enter key is used to select a desired instruction to execute. Similarly, when there is more than one instruction contained in an instruction bar, a pull-down menu would appear to show more instructions when the instruction bar is selected. While most programs provide the function of speeding the selection of desired instructions using hot keys on the keyboard, it is not easy for general users or beginners to remember these hot keys.
3. A majority of software-controlled functions are available only through multiple operating procedures. The use of the mouse and the keyboard to execute these operating procedures is troublesome and inefficient, particularly for the aged and children, who have also become important computer users in the modern society.

Therefore, it is desirable to improve the conventional input control interface to overcome the complicate operating procedures in inputting instructions.

### SUMMARY OF THE INVENTION

A primary object of the present invention is to provide a method of as well as control software and means for controlling a computer through reading bar codes, in which an optical identifying unit is used to scan and read a bar code to quickly and precisely control the computer to execute relevant actions. With the method and control software and means of the present invention, the simple movement of reading a bar code substitutes for the complicate control procedures required in using the conventional input peripherals.

Another object of the present invention is to provide a method of as well as control software and means for controlling a computer through reading bar codes, in which bar codes readable by an optical identifying unit have words, graphs, symbols, or Braille added thereto to enable visual or touching identification thereof, so that relevant control actions could be executed more easily.

A further object of the present invention is to provide a method of as well as control software and means for controlling a computer through reading bar codes, in which an optically read bar code is converted into a digital signal, which is mapped by related control software to corresponding indexes, data, and control procedures for driving the computer to execute relevant functions.

To achieve the above and other objects, the method of the present invention includes the steps of:
(a) scanning and reading a bar code;
(b) converting the read bar code into a digital signal, and inputting the digital signal to a computer;
(c) using related control software to map the digital signal to a synopsis of functions to execute in the control software; and
(d) executing the functions in the synopsis corresponding to the digital signal of the read bar code.

The control software for implementing the method of the present invention is installed in an operating system of the computer in advance for driving the computer to execute relevant actions. The synopsis of functions to execute included in the control software corresponds to the digital signal of the read bar code to drive the computer to execute related functions. The synopsis of functions to execute includes at least one index, at least one data, and at least one control procedure.

The means for implementing the method of the present invention includes an optical identifying unit electrically connected to the computer for scanning and reading the bar code and converting the read bar code into the digital signal, which is mapped by the related control software to the corresponding synopsis of functions to execute; and at least one bar code readable by the optical identifying unit.

The optical identifying unit may be a bar code scanner, an optical bar code reader, or other optical apparatus adapted to identify a bar code.

In a preferred embodiment of the present invention, the bar code may be a one-dimensional, a two-dimensional, or a three-dimensional bar code.

The bar code may have words, graphs, or symbols added thereto for visual identification thereof. Or, the bar code may have Braille added thereto for touching identification thereof.

In using the present invention, a user first selects a bar code to scan, and then uses an optical identifying unit to scan the selected bar code and convert the read bar code into a digital signal, which is input to an operating system of the computer via a peripheral interface, such as USB, IR, PS2, RS232, IEEE1394, etc. The digital signal of the read bar code input to the computer is received and mapped by related control software installed in the computer to a synopsis of functions to execute in the control software, so as to locate an index and data in the synopsis corresponding to the digital signal, and execute a control procedure corresponding to the located index and data to drive the computer to execute relevant actions. Therefore, the method of the present invention for controlling a computer may substitute for the conventional input peripherals, including the mouse and the keyboard, and reduce the previous complicate control procedures to only one simple movement of reading a bar code. In this manner, the computer could be controlled in a much simpler, more accurate, and quicker manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the method of the present invention;

FIG. 2 is an example of synopsis of functions to execute contained in the control software of the present invention;

FIG. 3 schematically shows the means of the present invention for controlling computer through reading bar code;

FIG. 4 is a flowchart showing the use of the present invention to control a computer to do relevant actions;

FIG. 5 is another example of synopsis of functions to execute contained in the control software of the present invention for controlling a computer to play different segments on a compact disk;

FIG. 6 shows how the present invention controls a computer to execute the function of playing different segments on a compact disk;

FIG. 7 is a further example of synopsis of functions to execute contained in the control software of the present invention for controlling a computer to download files from a network; and

FIG. 8 shows how the present invention controls a computer to execute the function of downloading files from a network.

### DETAILED DESCRIPTION OF THE PREFERRED EMBODIMENTS

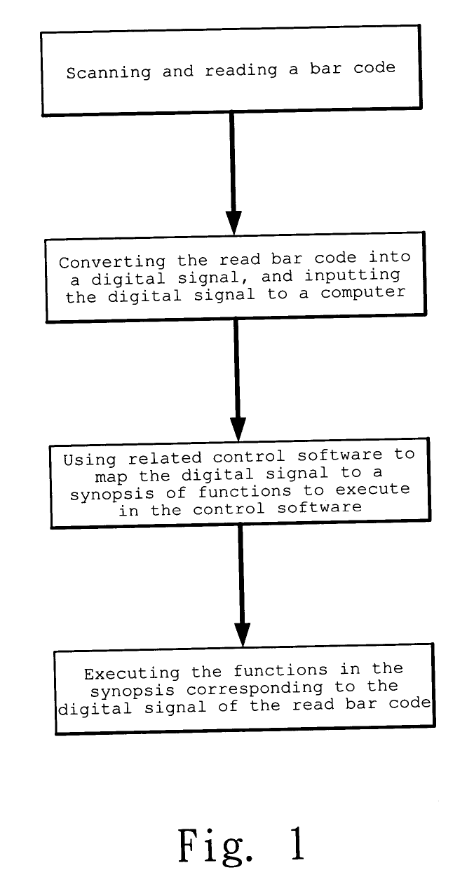

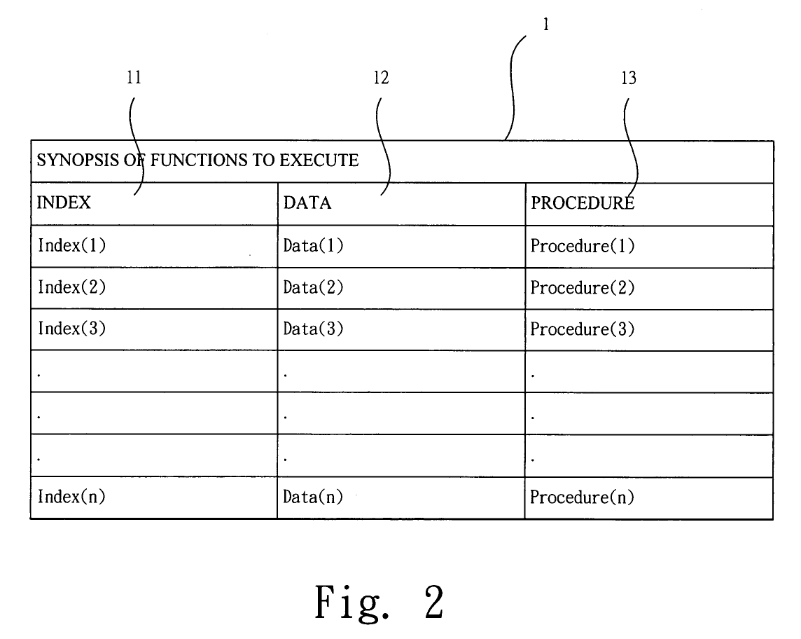

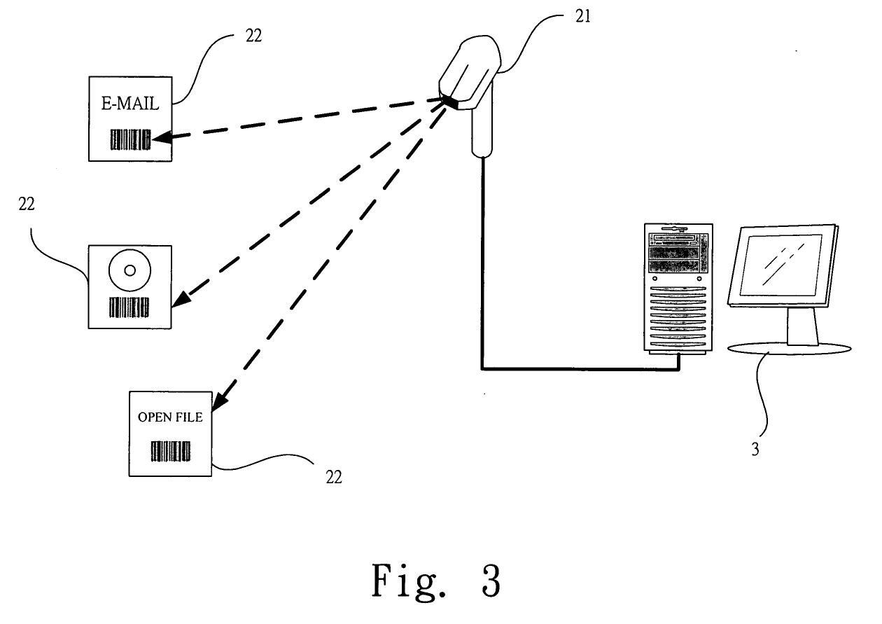

Please refer to FIG. 1 that is a block diagram showing a method of controlling computer through reading bar code according to the present invention, and to FIG. 2 that is an example of a synopsis of functions to execute container in control software of the present invention for implementing the method of the present invention, and to FIG. 3 that illustrates means for implementing the method of the present invention. As shown, the method of the present invention includes the following steps:
(a) Scanning and reading a bar code 22;
(b) Converting the read bar code into a digital signal, and inputting the digital signal to a computer 3;
(c) Using related control software to map the digital signal to a corresponding synopsis of functions to execute 1; and
(d) Executing the functions in the synopsis 1 corresponding to the digital signal of the read bar code.

The bar code 22 is scanned and read using an optical identifying unit 21, and the digital signal converted from the read bar code is input to an operating system (OS) of the computer 3 via a personal computer peripheral interface, such as a USB, an IR, a PS2, an RS232, or an IEEE1394 interface.

The control software is configured for implementing the method of the present invention, and is installed in the operating system of the computer 3 in advance for driving the computer 3 to execute relevant actions. The control software receives and maps the digital signal input to the computer 3 to the corresponding synopsis of functions to execute 1, which is included in the control software.

Please refer to FIG. 2. The synopsis of functions to execute 1 corresponds to a digital signal converted from the read bar code 22, and is used to drive the computer 3 to execute relevant functions.

The synopsis 1 includes at least one index 11 corresponding to the digital signal, at least one data 12 corresponding to the index 11 and accessible for use, and at least one control procedure 13 corresponding to the index 11 for driving a suitable computer peripheral to execute relevant actions.

The index 11, the data 12, and the control procedure 13 are established in the control software in advance, and may vary with actions of the computer peripheral to be driven. Therefore, the index 11, the data 12, and the control procedure 13 may be compiled according to actual need. By mapping the digital signal received by the control software to the synopsis of functions to execute 1 to locate corresponding index 11 and data 12, a corresponding control procedure 13 can be executed to drive the computer 3 to execute relevant actions.

Please refer to FIG. 3. The means for implementing the method of the present invention include an optical identifying unit 21 and at least one bar code 22 readable by the optical identifying unit 21. The optical identifying unit 21 is electrically connected to a computer 3 for scanning and reading the bar code 22 and converting the read bar code into a digital signal, which is then mapped by the control software installed in the computer 3 to a corresponding synopsis of functions to execute 1.

The optical identifying unit 21 may be a bar code scanner, an optical bar code reader, or other optical apparatus adapted to identify a bar code.

In a preferred embodiment of the present invention, the bar code 22 may be a one-dimensional bar code, a two-dimensional bar code, or a three-dimensional bar code.

The bar code 22 may have words, graphs, or symbols added thereto for visual identification thereof.

The bar code 22 may also have Braille added thereto for touching identification thereof.

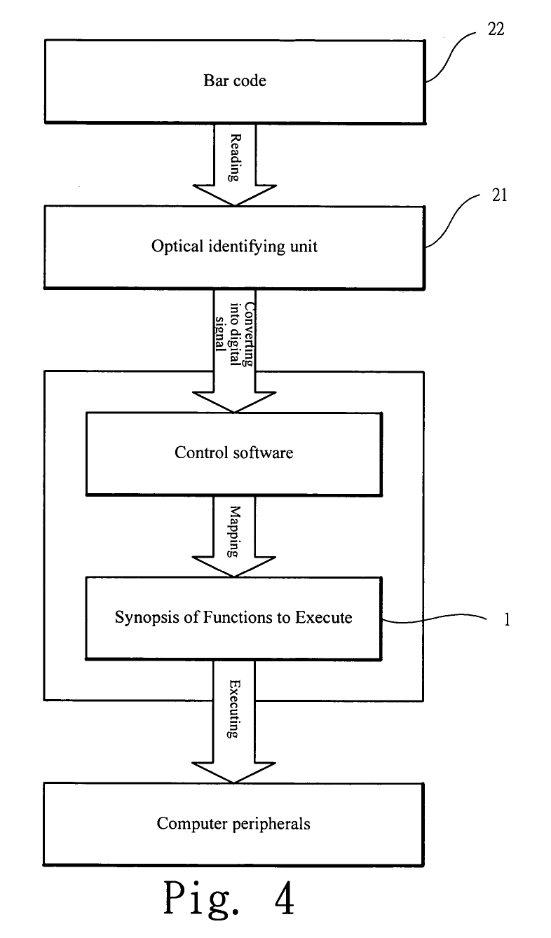

Please refer to FIG. 4 that is a flowchart showing the use of the present invention to control a computer to do relevant actions. First, a user selects a bar code 22 to be scanned, and then, uses the optical identifying unit 21 to scan and read the selected bar code 22. The bar code 22 read by the optical identifying unit 21 is converted into a digital signal, which is input to the operating system of the computer 3 via an existing peripheral interface, and received by the related control software installed in the operating system of the computer 3. The control software maps the received digital signal to the corresponding synopsis of functions to execute 1. From the synopsis 1, matching index 11 and data 12 are located and control procedure 13 corresponding to the matching index 11 and data 12 is executed to drive the computer 3 to execute relevant actions. In this manner, the method and means of the present invention may substitute for the conventional input peripherals, and reduces the previous complicate control procedures to a simple movement of reading bar code, so that the computer 3 and the peripherals thereof could be controlled to execute related actions in an easier, more accurate, and quicker manner.

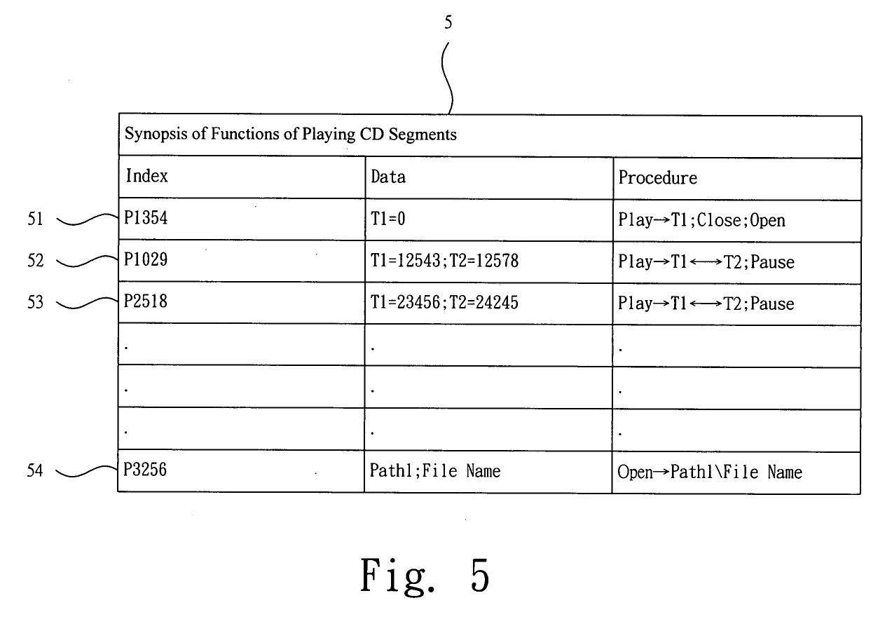

The method, the control software, and the means of the present invention may, for example, be employed to drive the computer 3 to play desired segments on a selected compact disk (CD). To do so, first install related control software in the operating system of the computer 3 for driving the computer 3 to execute relevant actions. The control software includes a synopsis of functions of playing CD segments 5, an example of which is shown in FIG. 5. As shown, the synopsis 5 includes a plurality of indexes 51, 52, 53, 54, each of which corresponds to a related data and a related control procedure in the synopsis 5.

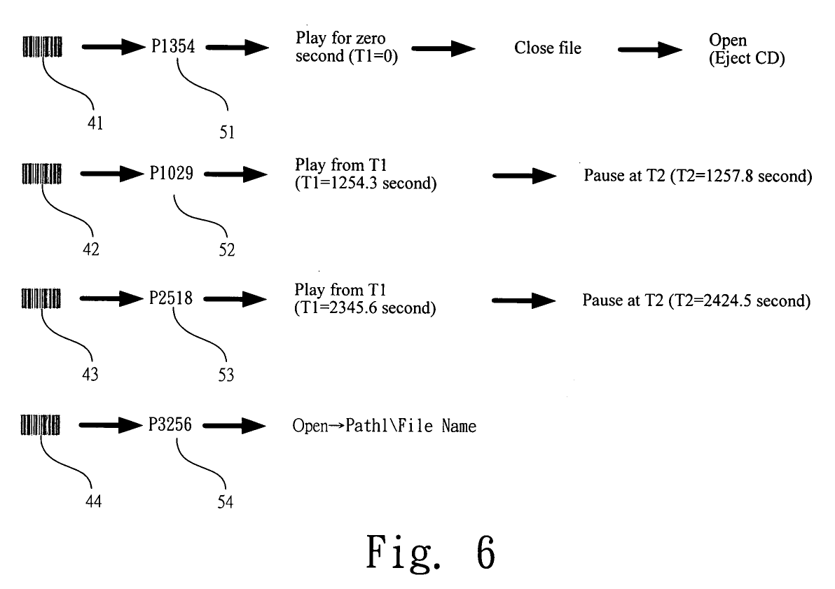

Please refer to FIG. 6 that shows how the present invention controls the computer 3 to execute the function of playing different segments on a compact disk. When a user inserts a compact disc into the computer 3 and uses the optical identifying unit 21 to sequentially scan an open bar code 41, a segment 1 bar code 42, a segment 2 bar code 43, and an execute bar code 44, the control software sequentially corresponds the scanned bar codes 41, 42, 43, 44 to the indexes 51, 52, 53, 54 in the synopsis 5 for driving the computer 3 to execute related actions of playing CD segments. In this example of using the present invention, the data and the control procedures corresponding to the indexes 51, 52, 53, 54 areas follows: Index 51 (P1354): Open the play function to play the segment 1 for a time period of zero second (T1=0); and then close the file and eject the compact disc. The above corresponding control procedure is briefly expressed as Play→T1; Close; Open.

Index 52 (P1029): Play the segment 1, starting from the time of 1254.3 second (T1=12543) and pausing at the time of 1257.8 second (T2=12578). The above corresponding control procedure is briefly expressed as Play→T1←→T2; Pause.

Index 53 (P2518): Play the segment 1, starting from the time of 2345.6 second (T1=23456) and pausing at the time of 2424.5 second (T2=24245). The above corresponding control procedure is briefly expressed as Play→T1←→T2; Pause.

Index 54 (P3256): Open a related play program and execute the play function thereof. The above corresponding control procedure is briefly expressed as Open→Path1\File name.

In other words, according to the synopsis 5, the computer 3 would open the related play program to enable the play function thereof, and play the segment 1 from the 1254.3 second to the 1257.8 second, and the segment 2 from the 2345.6 second to the 2424.5 second. When the desired segments have been played, the file is closed and the compact disk is ejected.

In this manner, the method, the control software, and the means of the present invention may substitute for the conventional input peripherals, such as the mouse and the keyboard, and reduces the previous complicate control procedures to a simple movement of reading a bar code, allowing a user to easily access and enjoy the segment 1 and segment 2 on the compact disk through much simpler operation on the computer 3.

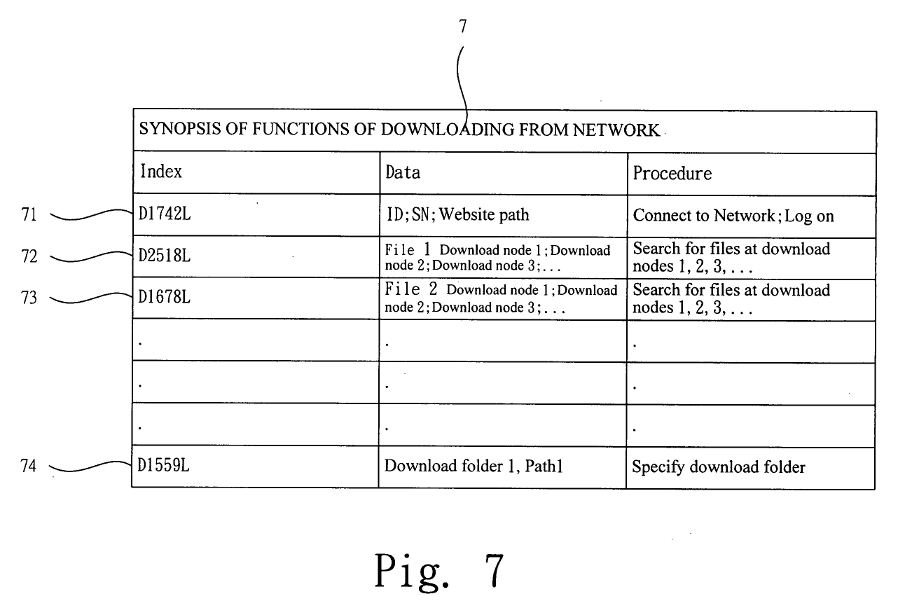

The method, the control software, and the means of the present invention may also be employed to drive the computer 3 to download files from a network. To do so, first install related control software in the operating system of the computer 3 for driving the computer 3 to execute relevant actions. The control software includes a synopsis of functions of downloading from network 7, an example of which is shown in FIG. 7. As shown, the synopsis 7 includes a plurality of indexes 71, 72, 73, 74, each of which corresponds to a related data and a related control procedure in the synopsis 7.

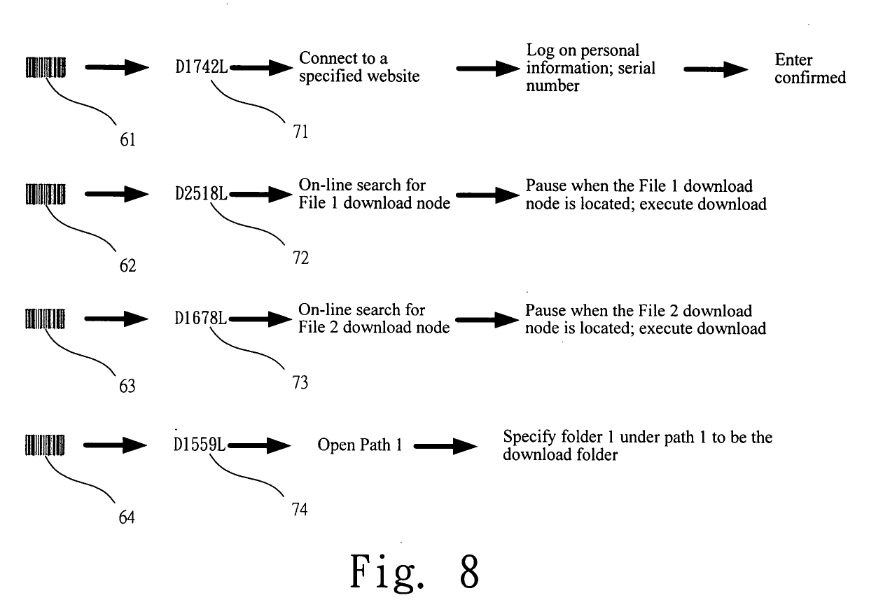

Please refer to FIG. 8 that shows how the present invention controls the computer 3 to execute the function of downloading files from a network. When a user uses the optical identifying unit 21 to sequentially scan a logon bar code 61, a download 1 bar code 62, a download 2 bar code 63, and a folder 1 bar code 64, the synopsis 7 in the control software sequentially corresponds the scanned bar codes 61, 62, 63, 64 to the indexes 71, 72, 73, 74 for driving the computer 3 to execute related actions of downloading files from the Internet and storing the downloaded files in a specific folder. In this example of using the present invention, the data and the control procedures corresponding to the indexes 71, 72, 73, 74 are as follows:

Index 71 (D1742L): Connect the computer 3 to a specified website, and log on required personal information and serial number.

Index 72 (D2518L): On-line search for File 1 download node, and pause when the File 1 download node is located. And then, execute the download of file 1.

Index 73 (D1678L): On-line search for File 2 download node, and pause when the File 2 download node is located. And then, execute the download of file 2.

Index 74 (D1559L): Open path 1 and specify the folder 1 under the path 1 to be the download folder. Through the movement of scanning bar codes, it is possible to simplify the previous complicate procedures for connecting the computer to a network, logging on, and downloading desired files, allowing a user to easily download desired files from the network and store the downloaded files in a specified folder in a much simpler operation on the computer 3.

The present invention can be further applied to more control functions. To do so, first establish all the indexes, data, and control procedures corresponding to each desired control function in a synopsis in the related control software. Then, a user may use the optical identifying unit to read desired bar codes and input digital signals of the read bar codes to the computer, and the computer is automatically driven to execute the corresponding control functions, such as search data, insert file, select, delete, open file and save file, open and close program, control multimedia playing, connect to network, upload, download, enable I/O control, receive and send mails, setup program function, log on personal information and serial number, enable super link, enable internal functions of programs, etc. In this manner, it is not necessary to use the conventional input peripherals, that is, the mouse and the keyboard, and all the complicate control procedures are reduced to a simple movement of reading bar codes, allowing a beginner in computer operation, a young computer user, and most general computer users to control the computer in an extremely simple, easy, accurate, and quick manner.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of controlling computer through reading bar code, comprising the steps of:
scanning and reading a bar code;
converting the read bar code into a digital signal, and inputting the digital signal to a computer;
using related control software to map the digital signal to a synopsis of functions to execute in the control software; and
executing the functions in the synopsis corresponding to the digital signal of the read bar code.

2. A control software for controlling computer through reading bar code, said control software being installed in an operating system of a computer in advance for driving the computer to execute relevant actions, comprising a synopsis of functions to execute corresponding to a digital signal converted from the read bar code for driving the computer to execute relevant actions.

3. The control software for controlling computer through reading bar code as claimed in claim 2, wherein the synopsis of functions to execute includes at least one index corresponding to the digital signal.

4. The control software for controlling computer through reading bar code as claimed in claim 2, wherein the synopsis of functions to execute includes at least one data corresponding to the index and accessible for use.

5. The control software for controlling computer through reading bar code as claimed in claim 2, wherein the synopsis of functions to execute includes at least one control procedure corresponding to the index for driving a computer peripheral to execute relevant actions.

6. A means for controlling computer through reading bar code, comprising:
an optical identifying unit electrically connected to a computer for scanning and reading a bar code, and converting the read bar code into a digital signal;
said digital signal being mapped by related control software to a corresponding synopsis of functions to execute contained in the control software; and
at least one bar code readable by the optical identifying unit.

7. The means for controlling computer through reading bar code as claimed in claim 6, wherein the optical identifying unit is a bar code scanner.

8. The means for controlling computer through reading bar code as claimed in claim 6, wherein the optical identifying unit is an optical bar code reader.

9. The means for controlling computer through reading bar code as claimed in claim 6, wherein the bar code is selected from the group consisting of one-dimensional, two-dimensional, and three-dimensional bar codes.

10. The means for controlling computer through reading bar code as claimed in claim 6, wherein the bar code has words added thereto for visual identification thereof.

11. The means for controlling computer through reading bar code as claimed in claim 6, wherein the bar code has graphs added thereto.

12. The means for controlling computer through reading bar code as claimed in claim 6, wherein the bar code has symbols added thereto.

13. The means for controlling computer through reading bar code as claimed in claim 6, wherein the bar code has Braille added thereto for touching identification thereof.
